(19) United States
(12) Patent Application Publication
(10) Pub. No.: US 2025/0178088 A1
(43) Pub. Date: Jun. 5, 2025

(54) LARGE-SCALE METAL ADDITIVE MANUFACTURING OF LOW-COST FEEDSTOCK

(71) Applicant: UT-Battelle, LLC, Oak Ridge, TN (US)

(72) Inventors: Adam Stevens, Lenoir City, TN (US); Sudarsanam Suresh Babu, Knoxville, TN (US); Rangasayee Kannan, Knoxville, TN (US); Vanshika Singh, Knoxville, TN (US); Peeyush Nandwana, Knoxville, TN (US); Brian Hicks, Knoxville, TN (US); Ryan R. Dehoff, Knoxville, TN (US); David A. Frederick, Maryville, TN (US); Sarah M. Graham, Knoxville, TN (US); Douglas J. Kyle, Knoxville, TN (US); Lonnie J. Love, Knoxville, TN (US); Roger G. Miller, Knoxville, TN (US); William H. Peter, Knoxville, TN (US); Brian K. Post, Knoxville, TN (US); Yukinori Yamamoto, Knoxville, TN (US)

(21) Appl. No.: 18/968,191

(22) Filed: Dec. 4, 2024

Related U.S. Application Data
(60) Provisional application No. 63/605,600, filed on Dec. 4, 2023.

(51) Int. Cl. B22F 10/22; B22F 12/10; B22F 12/53; B33Y 10/00; B33Y 30/00; B33Y 70/00

(52) U.S. Cl. CPC B22F 10/22; B22F 12/10; B22F 12/53; B22F 2301/35; B33Y 10/00; B33Y 30/00; B33Y 70/00

(57) ABSTRACT

A system and method of making an additively manufactured, metal near net shape part includes introducing a metallic-element-bearing feedstock into a melt zone of an additive manufacturing printhead. The metallic-element-bearing feedstock is mixed in the melt zone with a flux composition to form a slag bath mixture upon melting. The metallic-element-bearing feedstock is refined in-situ by melting the slag bath mixture with the application of thermal energy to the slag bath mixture to form a phase-separated product including a slag phase and a metal-rich liquid phase. The metal-rich liquid phase is simultaneously deposited to form a first metal layer that is one of a plurality of iteratively deposited metal layers of an additive build according to a three-dimensional digital model. The additive build has successive layers of the deposited, solidified metal-rich liquid that form a near net shape metallic part.

### CROSS-REFERENCE TO RELATED APPLICATIONS

This application claims the benefit of U.S. Provisional Application No. 63/605,600, filed Dec. 4, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of making near net shape metallic parts by additive manufacturing.

### BACKGROUND OF THE INVENTION

Current supply chains for large, multi-ton metal castings, such as those critical to the renewable energy industry, originate abroad. Foreign origination introduces significant transportation emissions, costs, and geostrategic risk into the procurement of these large castings. One method to domestically re-shore this manufacturing without resorting to capital-intensive conventional foundries is to utilize high-throughput welding processes for metal additive manufacturing (AM). To be cost-effective at scale, however, an AM process is needed that utilizes high-volume, low-cost feedstocks instead of conventional wires and powders that are currently employed.

For example, conventional electroslag additive manufacturing processes utilize a consumable feedstock electrode in the form of metal wire, strip, or ingot. Some electroslag processes have been shown to be capable of operating as a batch process by combining a non- consumable electrode such as graphite with a discontinuous feedstock. Similarly, discontinuous feedstocks have been used to augment filler metal deposition rates for the welding of large joints. However, a continued need exists for additive manufacturing processes that can utilize readily available, low-cost feedstocks to manufacture large, multi-ton parts at a low-cost and in an energy efficient manner.

### SUMMARY OF THE INVENTION

An improved method of making an additively manufactured, metal near net shape part is provided. The method includes introducing a metallic-element-bearing feedstock into a melt zone of an additive manufacturing printhead. The method further includes mixing the metallic-element-bearing feedstock in the melt zone with a flux composition to form a slag bath mixture upon melting. The method further includes refining the metallic-element-bearing feedstock in-situ by melting the slag bath mixture with the application of thermal energy to the slag bath mixture. The application of thermal energy to the slag bath mixture forms a phase-separated product including a slag phase and a metal-rich liquid phase. The method further includes simultaneously depositing the metal-rich liquid phase to form a first metal layer. The first metal layer is one of a plurality of iteratively deposited metal layers of an additive build according to a three-dimensional digital model, such that the additive build is comprised of successive layers of the deposited, solidified metal-rich liquid that form a near net shape metallic part.

In specific embodiments, the refining of the metallic-element-bearing feedstock and the deposition of the metal-rich liquid phase are performed as a single step to directly obtain the metal near net shape part from the metallic-element-bearing feedstock.

In specific embodiments, the metallic-element-bearing feedstock comprises one or more of direct reduced iron, hot briquetted iron, and pig iron.

In particular embodiments, the metallic-element-bearing feedstock further comprises one or more ferroalloy.

In specific embodiments, the flux composition comprises one or both of an oxide and a salt.

In particular embodiments, the flux composition comprises one or more of CaF₂, Al₂O₃, CaO, SiO₂, TiO₂, K₂O, Na₂O, and MnO.

In specific embodiments, the flux composition comprises waste byproducts of an industrial process.

In particular embodiments, the waste byproduct is red mud.

In specific embodiments, the application of thermal energy heats the slag bath mixture to a melt temperature in the range of approximately 1400 to 2500° C.

In specific embodiments, a residence time of the slag bath mixture in the melt pool is 60 minutes or less.

In specific embodiments, the thermal energy is provided as electrical energy that is applied to the slag bath mixture as one of direct current electrode positive (DCEP), direct current electrode negative (DCEN), alternating current (AC), or a combination thereof.

An additive manufacturing system is also provided. The additive manufacturing system includes an additive manufacturing printhead including a feedstock delivery unit and an energy delivery unit. The feedstock delivery unit is configured to deliver a metallic-element-bearing feedstock and a flux composition into an elevated temperature region generated by the energy delivery unit. The printhead is operable to directly refine the metallic-element-bearing feedstock in-situ in the elevated temperature region to form a phase-separated product including a slag phase and a metal-rich liquid phase. The printhead is operable to simultaneously deposit the metal-rich liquid phase to form a first metal layer. The first metal layer comprises one of a plurality of iteratively deposited metal layers of an additive build that is formed according to a three-dimensional digital model, such that the additive build is comprised of successive layers of the deposited metal-rich liquid that form a solidified near net shape metal part.

In specific embodiments, the printhead is configured to deposit the metal-rich liquid phase in one of a horizontal direction, a vertical direction, or a combination thereof relative to a direction of gravitational force.

In specific embodiments, the system further comprises a robotic arm coupled to the printhead, the robotic arm being operable to move both horizontally and vertically relative to a support surface on which the additive build is formed.

In specific embodiments, the printhead is stationary, and the system further includes a moveable stage having a support surface on which the additive build is formed.

In specific embodiments, the system further includes a first electrode electrically connected to the printhead, and a second electrode. Electrical energy is applied to the elevated temperature region via the first and second electrodes.

In particular embodiments, the electrical energy is one of direct current electrode positive (DCEP), direct current electrode negative (DCEN), alternating current (AC), or a combination thereof.

In particular embodiments, the second electrode is one of: i) electrically connected to the printhead; ii) electrically connected to a second printhead coupled to the printhead; or iii) electrically connected to a support surface on which the additive build is formed.

In particular embodiments, one or both of the first and second electrodes is consumable, serving as both a current-carrying electrode and the metallic-element-bearing feedstock.

In specific embodiments, the metallic-element-bearing feedstock is a continuous feedstock or a discontinuous feedstock.

In specific embodiments, the metallic-element-bearing feedstock comprises one or more of direct reduced iron, hot briquetted iron, and pig iron.

In particular embodiments, the metallic-element-bearing feedstock further comprises one or more ferroalloy.

In specific embodiments, the flux composition comprises one or both of an oxide and a salt.

In particular embodiments, the flux composition comprises one or more of CaF₂, Al₂O₃, CaO, SiO₂, TiO₂, K₂O, Na₂O, and MnO.

These and other features of the invention will be more fully understood and appreciated by reference to the description of the embodiments and the drawings.

### BRIEF DESCRIPTION OF THE DRAWINGS

FIG. 1 is a schematic view of a method of making an additively manufactured, metal near net shape part in accordance with embodiments of the disclosure;

FIG. 2 is a perspective view of an additive manufacturing system in accordance with some embodiments of the disclosure;

FIG. 3 is a side view of an additive manufacturing system in accordance with other embodiments of the disclosure;

FIG. 4 is a side view of an additive manufacturing system in accordance with yet other embodiments of the disclosure;

FIG. 5 is a graph showing equilibrium mass of phases at 1600° C. according to computational thermodynamic modeling;

FIG. 6 is a graph showing the composition of the iron-rich liquid phase at 1600° C. according to computational thermodynamic modeling; and

FIG. 7 is a pictorial view of metal and slag phase separation obtained by heating a crucible containing direct reduced iron and a flux composition.

### DETAILED DESCRIPTION OF THE CURRENT EMBODIMENTS

As discussed herein, the current embodiments relate to a system and method of making an additively manufactured, metal near net shape part. The method, which may be referred to as refining electroslag additive manufacturing (RESAM), produces a near-net shape metal phase by in-situ refinement of metal feedstocks in a slag bath. The refinement takes place directly in connection with the deposition of material to form an additive build. The all-electric process is capable of alloying and depositing metals at build rates on the order of 10-100+ kg/hour while using readily available, low-cost materials such as low-embodied carbon steelmaking feedstocks. In contrast to conventional additive manufacturing processes that produce large-scale, near net shapes utilizing feedstocks produced via traditional steelmaking routes (e.g., welding wires), RESAM eliminates the intermediate steps and the associated carbon emissions, energy, and cost.

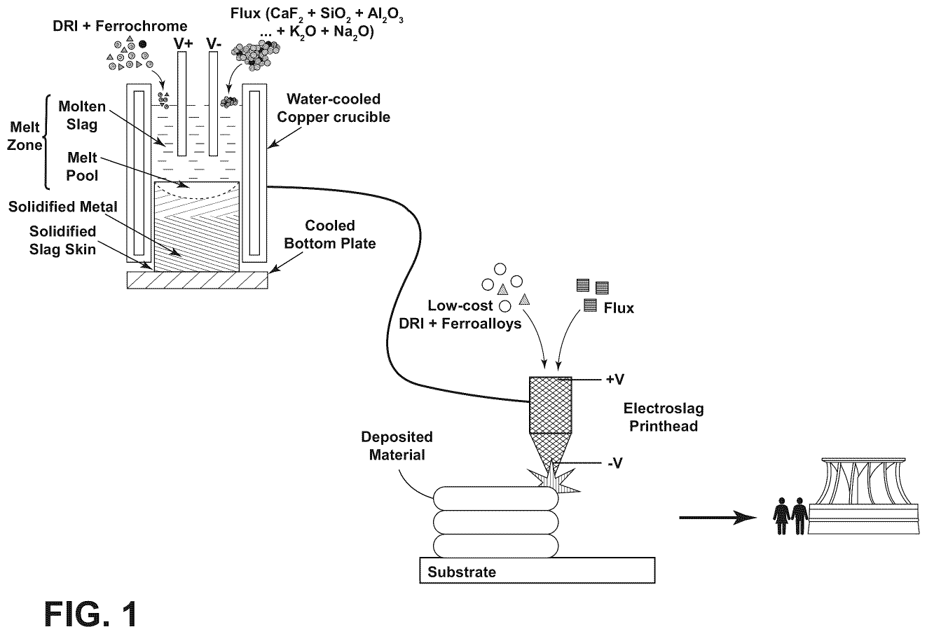

As shown schematically in FIG. 1, the method first includes introducing a metallic-element-bearing feedstock into a melt zone of an additive manufacturing printhead. The metallic-element-bearing feedstock may be a continuous feedstock such as a powder cored wire or alternatively may be a discontinuous feedstock such as pellets. In various embodiments, the metallic-element-bearing feedstock may include iron (Fe) and/or iron metallics. For example, the metallic-element-bearing feedstock may include direct reduced iron (DRI). DRI is produced from the direct reduction of iron ore into iron by a reducing gas including carbon and/or hydrogen. For example, DRI may be produced from pelletized iron ore (Fe₂O₃) by the following chemical reactions: 3Fe₂O₃→CO/H₂→2Fe₃O₄+CO₂/H₂O; Fe₃O₄+CO/H₂→3FeO+CO₂/H₂O; FeO+CO/H₂→Fe+CO₂/H₂O. Alternatively or in addition, the metallic-element-bearing feedstock may include hot briquetted iron and/or pig iron. Further, the metallic-element-bearing feedstock may additionally include one or more ferroalloy such as but not limited to FeSi, FeMn, and/or a ferrochrome. In other embodiments, however, the metallic element may be a metal other than iron. Ferroalloys such as FeSi and FeMn can be used for both alloy chemistry control and, for certain ferroalloys, as an additional reductant delivery mechanism (for example, Si will preferentially react with the oxygen in Fe₂O₃ to reduce iron oxide to metallic iron, with slag-forming SiO₂ as a byproduct). Some fraction of ferroalloy alloying elements may end up in the slag.

The method next includes mixing the metallic-element-bearing feedstock in the melt zone with a flux composition to form a slag bath mixture upon melting of the metallic-element-bearing feedstock and flux composition. The melt zone may be contained within a vessel in the printhead itself, and hence the mixing may occur within the printhead, or alternatively the feedstock and flux composition may be mixed directly on a working support surface such that the melt zone is adjacent to the printhead. The flux composition includes an oxide, a salt, or both. In various embodiments, the flux composition includes one or more of CaF₂, Al₂O₃, CaO, SiO₂, TiO₂, K₂O, Na₂O, and MnO. The flux composition may be a commercially available flux composition having a predetermined weight percent of components, or may be any other number and amount of flux components. The flux composition also may include byproducts and waste material from industrial processes, such as but not limited to red mud (bauxite residue), which may include Fe₂O₃, Al₂O₃, CaO, SiO₂, TiO₂, and/or Na₂O as components.

The method next includes refining the metallic-element-bearing feedstock in-situ in the melt zone and simultaneously depositing refined material via the printhead. More particularly, the slag bath mixture is melted by the printhead applying thermal energy to the mixture to create the melt zone. The thermal energy may be provided in the form of an electrical current that is applied to the mixture to heat the mixture to a temperature in the range of approximately 1400 to 2500° C. to form the slag bath. The temperature is dependent upon the melting temperature of the components of the slag bath mixture, such that the slag bath mixture must be heated at least to the melting temperature of the slag bath mixture. As shown in FIG. 1 and described in greater detail below, the printhead may include electrodes that are electrically connected to the printhead. In these embodiments, the two electrodes are non-consumable electrodes that do not become part of the slag bath mixture. The electrical current is applied through the electrodes and may be applied as direct current electrode positive (DCEP), direct current electrode negative (DCEN), alternating current (AC), or a combination thereof, such as, for example, digital waveforms with offsets. In other embodiments, one of the electrodes may be located on the printhead while the other electrode may be located on a support surface on which the refined material is deposited such that the other electrode is grounded through the part that is formed by the deposited material. In these embodiments, the metallic-element-bearing feedstock may function as the other electrode such that the other electrode is a consumable electrode that is both an electrode and also used to form the part. In yet other embodiments, one electrode may be located on a first printhead, and the other electrode may be located on a second printhead that operates in tandem with the first printhead such that the electrical current passes through both printheads. Further, in the embodiments in which the melt zone is within the printhead, the refined material may be formed in the printhead and simultaneously deposited from the printhead via a nozzle or similar. Alternatively, in the embodiments in which the melt zone is external to the printhead, the feedstock and flux composition may be deposited from the printhead onto a part under construction and simultaneously refined in the melt zone by application of thermal energy to the mixture by the printhead.

Melting of the slag bath mixture forms a phase-separated product including a slag phase and a separate metal-rich liquid phase such as an iron-rich liquid phase. The metal-rich liquid phase is the refined material that may be used to form the part. In conjunction with the refinement of the slag bath mixture, the obtained metal-rich liquid phase is deposited to iteratively form successive layers of the additive build to form the metal near net shape part directly from the metallic-element-bearing feedstock in a single step. In some embodiments, the metal near net shape part is an iron near net shape part or a steel near net shape part. The part may have a weight in the order of tons and may be a large part that is far greater in size than a human. The additive build is formed according to a three-dimensional digital model stored in a computer and includes a plurality of layers of the deposited, solidified metal-rich liquid. The printhead is operated by the computer to deposit the layers of metal-rich liquid in locations dictated by the three-dimensional digital model. In some embodiments, the printhead may be coupled to a robotic arm that is moveable in a horizontal direction, a vertical direction, or a combination of both horizontal and vertical directions in order for the printhead to deposit the metal-rich liquid to form the part on a stationary support surface. In other embodiments, the printhead may be stationary, and the support surface is located on a moveable stage that moves in horizontal and/or vertical directions relative to the printhead. Further, the printhead may be configured to deposit the metal-rich liquid in a vertical direction relative to the direction of gravitational force, i.e. depositing in a direction generally parallel to gravitational force, or may be configured to deposit the metal-rich liquid in a horizontal direction relative to the direction of gravitational force, i.e., depositing in a direction generally perpendicular to gravitational force, or a combination of vertical and horizontal directions.

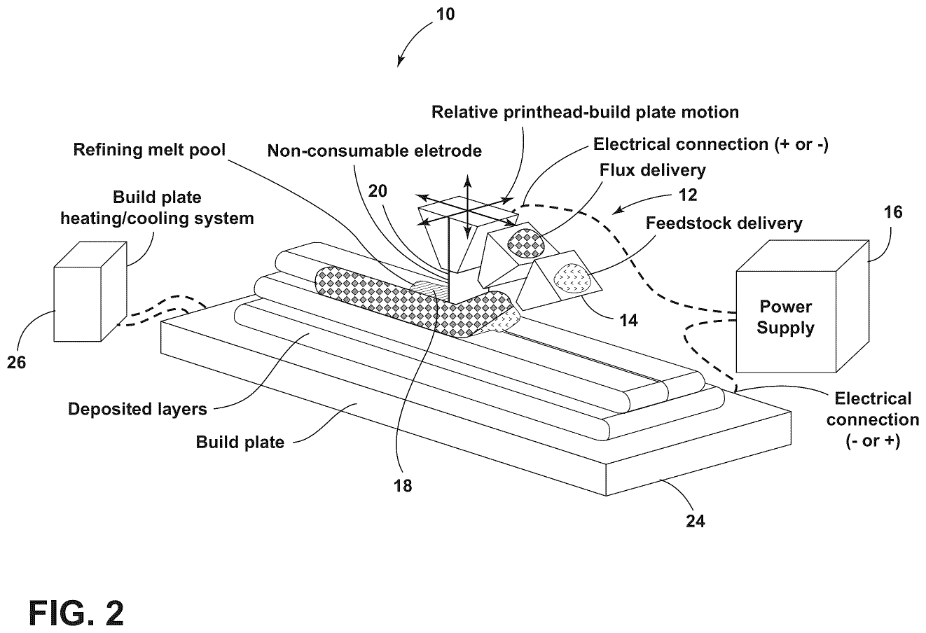

More particularly, with reference to FIG. 2, in some embodiments an additive manufacturing system 10 that performs the method includes an additive manufacturing printhead 12 having a feedstock delivery unit 14 and an energy delivery unit 16. The energy delivery unit 16 generates an elevated temperature region including the melt zone 18 by providing thermal energy such as via electrical current. The system includes a single non-consumable electrode 20 connected to the printhead and receiving power from the energy delivery unit 16, and the energy delivery unit is also connected to the build plate 24 on which the layers of material are deposited. The feedstock delivery unit 14 delivers the metallic-element-bearing feedstock to the melt zone in the elevated temperature region and may also deliver the flux composition to the melt zone. The melt pool zone is formed on the support surface of the build plate 24 as the layers of material are deposited on the build plate. The melt pool is a combination of molten slag and metal. The printhead is operable to move in a combination of horizontal and vertical directions in the x, y, and z planes. As shown, the system 10 also may optionally include a heating/cooling unit 26 that can control the temperature of the build plate 24.

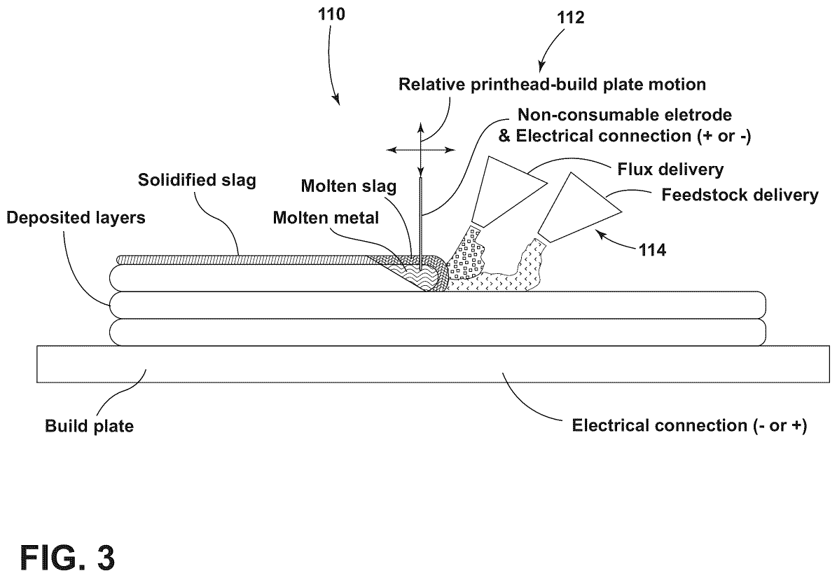

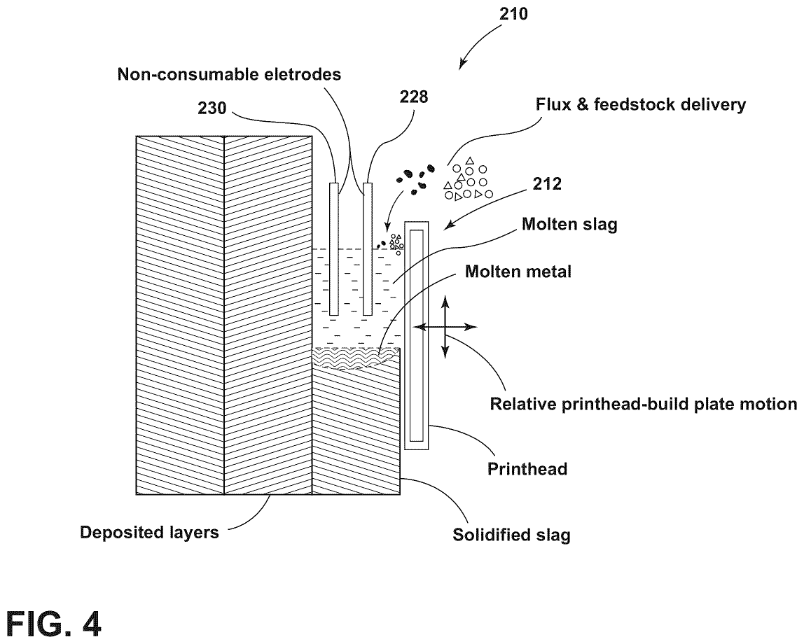

With reference next to FIG. 3, in some embodiments the system 110 is capable of depositing material on a horizontal surface with the material being deposited in a vertical direction relative to the gravitational force. The feedstock delivery unit 114 delivers the feedstock and flux into a melt zone generated by a single, non-consumable electrode connected to the printhead 112. In other embodiments shown in FIG. 4, the system 210 is capable of depositing material on a vertical surface with the material being deposited in a direction parallel to the gravitational force. Feedstock and a flux composition are delivered into the slag bath in the melt zone where a phase-separated product is formed within the printhead 212, leaving behind a vertically-oriented metal bead that partially solidifies within the printhead, prior to deposition. In these embodiments, the printhead 212 includes dual (first and second) non-consumable electrodes 228, 230 that generate the melt zone within the printhead 212.

### EXAMPLES

The present method is further described in connection with the following examples, which are intended to be non-limiting.

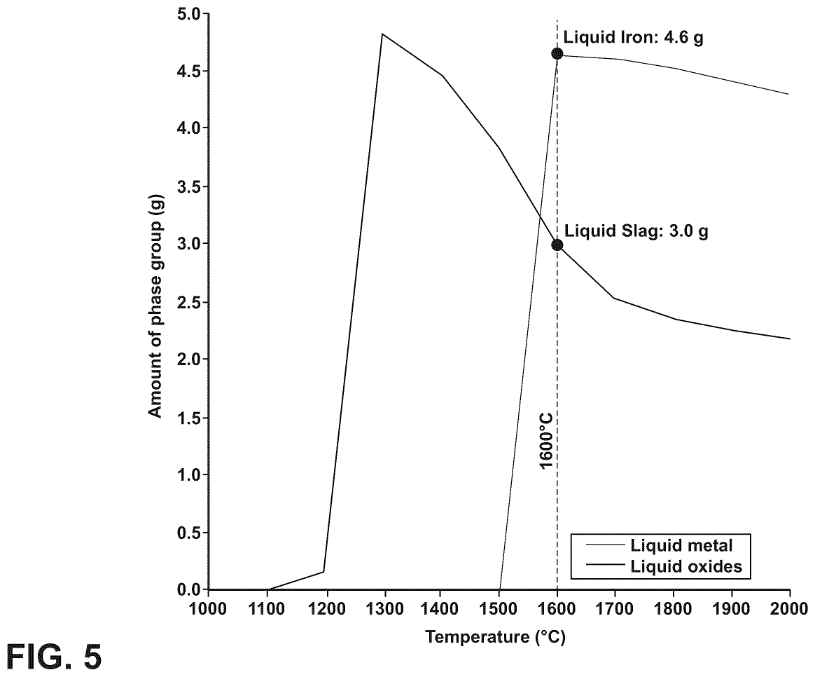

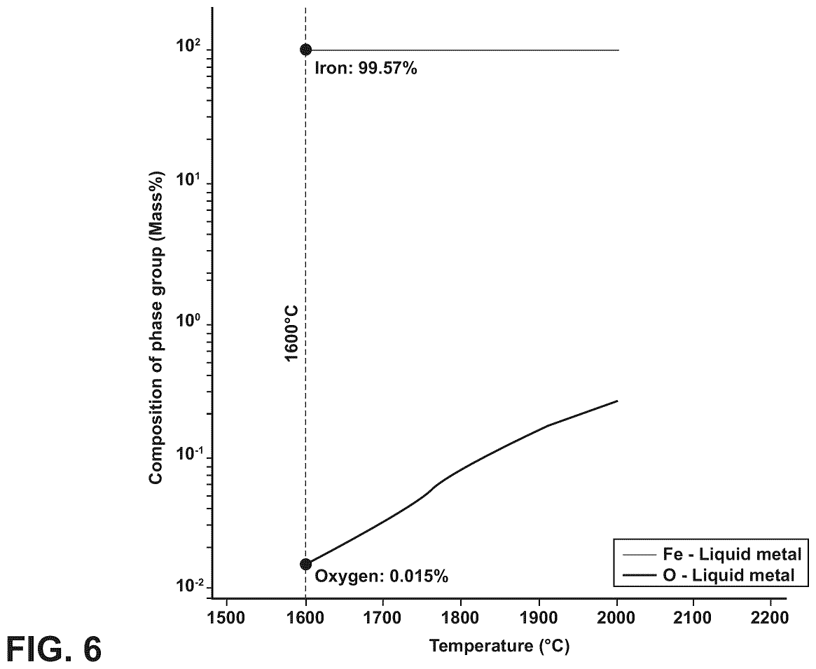

Computational thermodynamic modeling (via ThermoCalc) of 10 g of a combination of DRI and electroslag fluxes in 50:50 weight ratio was performed. Particularly, differently reduced DRI (carbon-and hydrogen-reduced) were studied for iron-and slag-phase formation. DRI reduced via a carbon (natural-gas) method (gas composition 30% CO, 15% CO₂, 45% H₂, and 10% N₂) consists of 94.3% Fe, 0.65% MgO, 1.24% CaO, 1.73% SiO₂, 0.47% Al₂O₃, 0.26% MnO, 0.065% TiO₂, 0.033% Na₂O, 0.015% K₂O, 0.008% P, 0.01% C, and 0.002% S (all in mass percent, as determined via Inductively Coupled Plasma analysis). DRI reduced via the H₂ method is typically the same composition in weight percentage as carbon (natural-gas) reduced DRI. The commercial electroslag flux composition used primarily consists of 65% CaF₂, 25% Al₂O₃, 6% SiO₂, 2% (Na₂O+K₂O) (all in mass percent). As shown in FIG. 5, the model predicted the separation and formation of a liquid iron phase at ≥1600° C. The model predicted the liquid phases, consisting of 4.6 g of iron-rich liquid and 3.0 g of slag, will phase separate, with the desired iron-rich liquid consisting of predominantly Fe while the slag phase consists of liquid (Al, Mg, Ti, Si) rich oxide and liquid calcium fluoride. The iron rich liquid phase becomes the printed deposit. FIG. 6 shows the phase compositions at 1600° C. indicating the iron-rich phase is predicted to consist of 99.57% iron and 0.015% oxygen. The iron-rich liquid phase-separates and forms the printed “bead,” which can be iteratively built up to perform additive manufacturing.

Similar thermodynamical modeling was performed for varying compositions of fluxes and DRI in 50:50 weight ratios. A flux composition primarily containing CaF₂ (40-67%), Al₂O₃ (22-25%), Fe₂O₃ (0-16%), SiO₂ (6-7%), CaO (0.2-3%), Na₂O+K₂O (2.0-3.6%), and TiO₂ (0-3.7%) can be utilized for producing ˜99% pure Fe. The range of the fluxes can be optimized further for desired kinetics and composition required in the final product.

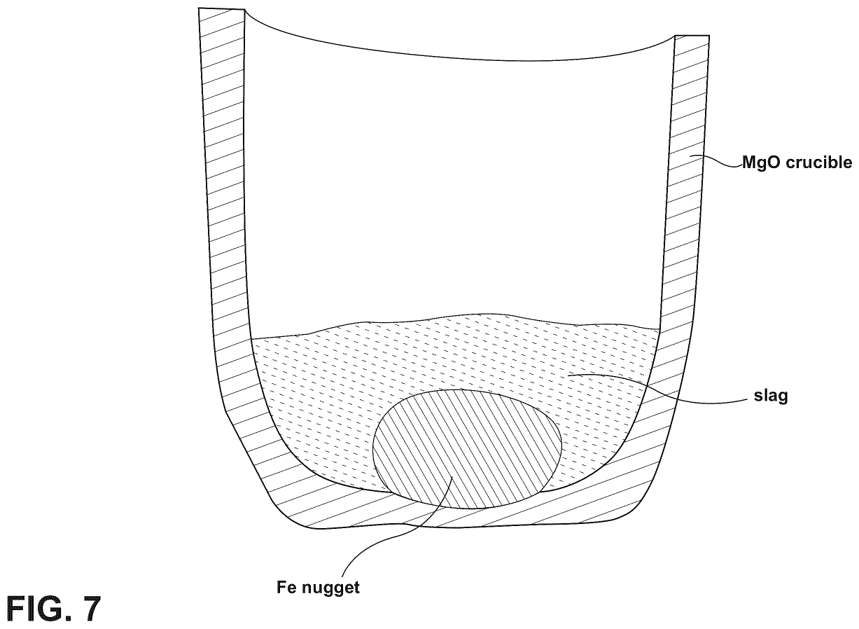

Laboratory examples were performed to illustrate the refining ability of DRI with commercial flux and the resulting iron production. As shown in FIG. 7, a 99.85% pure iron nugget was produced when commercial flux (65% CaF₂, 25% Al₂O₃, 6% SiO₂, 2% Na₂O+K₂O) and DRI was mixed in a 50:50 weight ratio and heated in a MgO crucible to 1650° C. for a residence time of 60 minutes. Similar examples were performed with varying compositions of fluxes and hold times, all leading to successful production of phase-separated iron. Hold times were varied from the order of minutes to seconds, with all resulting in Fe-slag interface separation. The examples successfully demonstrated the formation of iron nuggets for peak temperatures up to 1600° C., hold times up to 30 seconds with a heating ramp rate of 10° C./s. These results indicate that the kinetics of the melting and phase-separation process are sufficiently fast for a continuous additive manufacturing system utilizing the RESAM process disclosed herein.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of making an additively manufactured, metal near net shape part, the method comprising:
introducing a metallic-element-bearing feedstock into a melt zone of an additive manufacturing printhead;
mixing the metallic-element-bearing feedstock in the melt zone with a flux composition to form a slag bath mixture upon melting;
refining the metallic-element-bearing feedstock in-situ by melting the slag bath mixture with the application of thermal energy to the slag bath mixture, wherein the application of thermal energy to the slag bath mixture forms a phase-separated product including a slag phase and a metal-rich liquid phase;
simultaneously depositing the metal-rich liquid phase to form a first metal layer, wherein the first metal layer is one of a plurality of iteratively deposited metal layers of an additive build according to a three-dimensional digital model, such that the additive build is comprised of successive layers of the deposited, solidified metal-rich liquid that form a near net shape metallic part.

2. The method of claim 1, wherein the refining of the metallic-element-bearing feedstock and the deposition of the metal-rich liquid phase are performed as a single step to directly obtain the metal near net shape part from the metallic-element-bearing feedstock.

3. The method of claim 1, wherein the metallic-element-bearing feedstock comprises one or more of direct reduced iron, hot briquetted iron, and pig iron.

4. The method of claim 3, wherein the metallic-element-bearing feedstock further comprises one or more ferroalloy.

5. The method of claim 1, wherein the flux composition comprises one or both of an oxide and a salt.

6. The method of claim 5, wherein the flux composition comprises one or more of CaF₂, Al₂O₃, CaO, SiO₂, TiO₂, K₂O, Na₂O, and MnO.

7. The method of claim 1, wherein the flux composition comprises waste byproducts of an industrial process.

8. The method of claim 7, wherein the waste byproduct is red mud.

9. The method of claim 1, wherein the application of thermal energy heats the slag bath mixture to a melt temperature in the range of approximately 1400 to 2500° C.

10. The method of claim 1, wherein a residence time of the slag bath mixture in the melt pool is 60 minutes or less.

11. The method of claim 1, wherein the thermal energy is provided as electrical energy that is applied to the slag bath mixture as one of direct current electrode positive (DCEP), direct current electrode negative (DCEN), alternating current (AC), or a combination thereof.

12. An additive manufacturing system comprising:
an additive manufacturing printhead including a feedstock delivery unit and an energy delivery unit, the feedstock delivery unit being configured to deliver a metallic-element-bearing feedstock and a flux composition into an elevated temperature region generated by the energy delivery unit;
wherein the printhead is operable to directly refine the metallic-element-bearing feedstock in-situ in the elevated temperature region to form a phase-separated product including a slag phase and a metal-rich liquid phase, and wherein the printhead is operable to simultaneously deposit the metal-rich liquid phase to form a first metal layer, the first metal layer comprising one of a plurality of iteratively deposited metal layers of an additive build that is formed according to a three-dimensional digital model, such that the additive build is comprised of successive layers of the deposited metal-rich liquid that form a solidified near net shape metal part.

13. The system of claim 12, wherein the printhead is configured to deposit the metal-rich liquid phase in one of a horizontal direction, a vertical direction, or a combination thereof relative to a direction of gravitational force.

14. The system of claim 12, wherein the system further comprises a robotic arm coupled to the printhead, the robotic arm being operable to move both horizontally and vertically relative to a support surface on which the additive build is formed.

15. The system of claim 12, wherein the printhead is stationary, and the system further comprises a moveable stage including a support surface on which the additive build is formed.

16. The system of claim 12, wherein the system further comprises a first electrode electrically connected to the printhead, and a second electrode, wherein electrical energy is applied to the elevated temperature region via the first and second electrodes.

17. The system of claim 16, wherein the electrical energy is one of direct current electrode positive (DCEP), direct current electrode negative (DCEN), alternating current (AC), or a combination thereof.

18. The system of claim 16, wherein the second electrode is one of: i) electrically connected to the printhead; ii) electrically connected to a second printhead coupled to the printhead; or iii) electrically connected to a support surface on which the additive build is formed.

19. The system of claim 16, wherein one or both of the first and second electrodes is consumable, serving as both a current-carrying electrode and the metallic-element-bearing feedstock.

20. The system of claim 12, wherein the metallic-element-bearing feedstock is a continuous feedstock or a discontinuous feedstock.

21. The system of claim 12, wherein the metallic-element-bearing feedstock comprises one or more of direct reduced iron, hot briquetted iron, and pig iron.

22. The system of claim 21, wherein the metallic-element-bearing feedstock further comprises one or more ferroalloy.

23. The system of claim 12, wherein the flux composition comprises one or both of an oxide and a salt.

24. The system of claim 23, wherein the flux composition comprises one or more of CaF₂, Al₂O₃, CaO, SiO₂, TiO₂, K₂O, Na₂O, and MnO.
